(19) United States
(12) Patent Application Publication
(10) Pub. No.: US 2011/0145875 A1
(43) Pub. Date: Jun. 16, 2011

(54) MOBILE SET-TOP BOX AND METHOD FOR PROVIDING INTERNET PROTOCOL TELEVISION SERVICE USING THE SAME

(75) Inventor: Young-il KIM, Daejeon (KR)

(73) Assignee: Electronics and Telecommunications Research Institute, Daejeon (KR)

(21) Appl. No.: 12/911,206

(22) Filed: Oct. 25, 2010

(30) Foreign Application Priority Data
Dec. 11, 2009 (KR) 10-2009-0123307
Mar. 25, 2010 (KR) 10-2010-0026782

(51) Int. Cl. H04N 7/173

(52) U.S. Cl. 725/110

(57) ABSTRACT

Provided is a mobile set-top box. In the mobile set-top box, a demultiplexer processor separates first metadata from a transport stream corresponding to a broadcasting stream of which a destination is the mobile set-top box, and separates second metadata being transmitted via another channel, among a plurality of transport streams. A metadata processor unifies the first metadata and the second metadata and the image data transcoder processor transcodes image data included in the transport stream of the broadcasting stream into image data decodable by a user terminal. The metadata unified by the metadata processor and the transcoded image data are multiplexed by the multiplexer and then are transmitted to the user terminal. The mobile set-top box provides an Internet protocol television (IPTV) service to portable terminals of passengers boarding in a moving transportation means such as a bus, a train, and a ship.

### CROSS-REFERENCE TO RELATED APPLICATION

This application claims priority to and the benefit of Korean Patent Application Nos. 10-2009-0123307 and 10-2010-0026782 filed in the Korean Intellectual Property Office on Dec. 11, 2009 and Mar. 25, 2010, the entire contents of which are incorporated herein by reference.

### BACKGROUND OF THE INVENTION

(a) Field of the Invention

The present invention relates to an Internet protocol television (IPTV) set-top box that may provide an IPTV service and a method for providing internet protocol television service using the same.

(b) Description of the Related Art

A current public transportation means such as a train, a bus, a ship, and the like may receive a mobile television (TV) service via a satellite digital multimedia broadcasting (DMB). However, due to the absence of an uplink, the public transportation means may not receive various bi-directional Internet protocol television (IPTV) services such as a video on demand (VoD) service while moving.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provides a mobile set-top box and method of providing an Internet protocol television (IPTV) service in a moving transportation means.

An exemplary embodiment of the present invention provides a method of providing an IPTV service in a set-top box, including:

separating, from a plurality of transport streams, a transport stream corresponding to a broadcasting program being transmitted to a mobile set-top box installed in a moving transportation means, as a destination, when the plurality of transport streams are transmitted from an IPTV network; separating, from the separated transport stream, metadata required to play image data and the image data; and assigning an Internet protocol (IP) address to data obtained by multiplying the metadata and the image data to thereby transmit the data to a user terminal.

Another embodiment of the present invention provides a mobile set-top box of providing an IPTV service, including:

a demultiplexer processor that separates first metadata from a transport stream corresponding to a broadcasting stream of which a destination is the mobile set-top box, and separates second metadata being transmitted via another channel, among a plurality of transport streams transmitted from an IPTV network;

a metadata processor that unifies the first metadata and the second metadata; an image data transcoder processor that transcodes image data included in the transport stream corresponding to the broadcasting stream into image data decodable by a user terminal when an image codec of the IPTV network is different from an image codec of the user terminal; a multiplexer that multiplexes the metadata unified by the metadata processor and the transcoded image data; and a main processor to control data multiplexed by the multiplexer to be transmitted to the user terminal to which an IP address is assigned.

### BRIEF DESCRIPTION OF THE DRAWINGS

FIG. 1 is a schematic diagram illustrating an Internet protocol television (IPTV) service applying a mobile set-top box according to an exemplary embodiment of the present invention;

FIG. 2 is a block diagram illustrating an internal configuration of a mobile set-top box according to an exemplary embodiment of the present invention;

FIG. 3 is a flowchart illustrating a downlink operation for providing an IPTV service in a mobile set-top box according to an exemplary embodiment of the present invention; and

FIG. 4 is a flowchart illustrating an uplink operation for providing an IPTV service in a mobile set-top box according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In specification, In addition, unless explicitly described to the contrary, the word “comprise” and variations such as “comprises” or “comprising”, will be understood to imply the inclusion of stated elements but not the exclusion of any other elements.

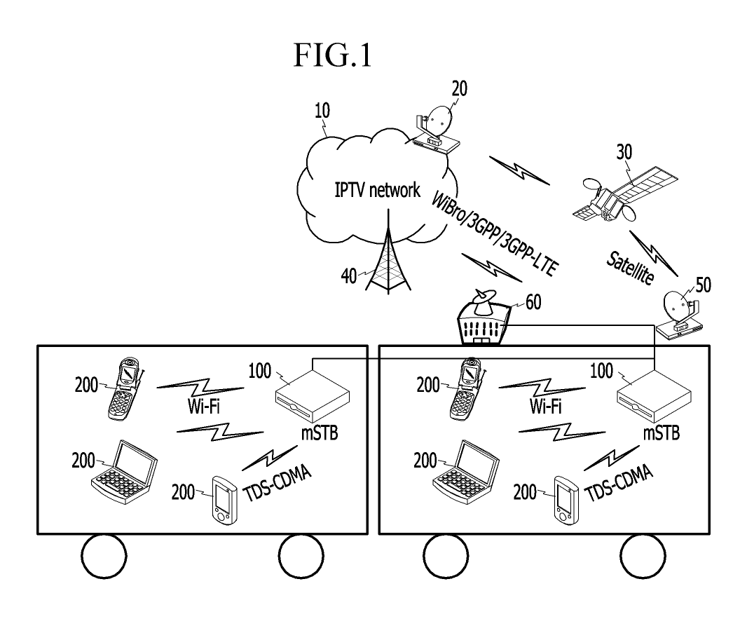

FIG. 1 is a schematic diagram illustrating an Internet protocol television (IPTV) service applying a mobile set-top box according to an exemplary embodiment of the present invention.

According to an exemplary embodiment of the present invention, an IPTV network 10 may provide a mobile IPTV service in interoperation with satellite networks 20 and 30, a wireless broadband (WiBro), a 3rd generation partnership project (3GPP), a 3PP-long term evolution (LTE), and a wireless access network 40 of an international mobile telecommunication (IMT)-advanced WiBro network.

A public transportation means such as a train, a bus, and a ship may include antennas 50 and 60 for transmitting and receiving a wireless signal for interoperation with the IPTV network 10, a mobile set-top box 100, and a plurality of user terminals 200 of passengers. Here, the mobile set-top box 100 and the plurality of user terminals 200 may be connected to each other using various types of mobile communication schemes, for example, a wireless-fidelity (Wi-Fi) scheme, a worldwide interoperability for microwave access (WiMax) scheme, a TDS-code division multiple access (CDMA) scheme, and the like.

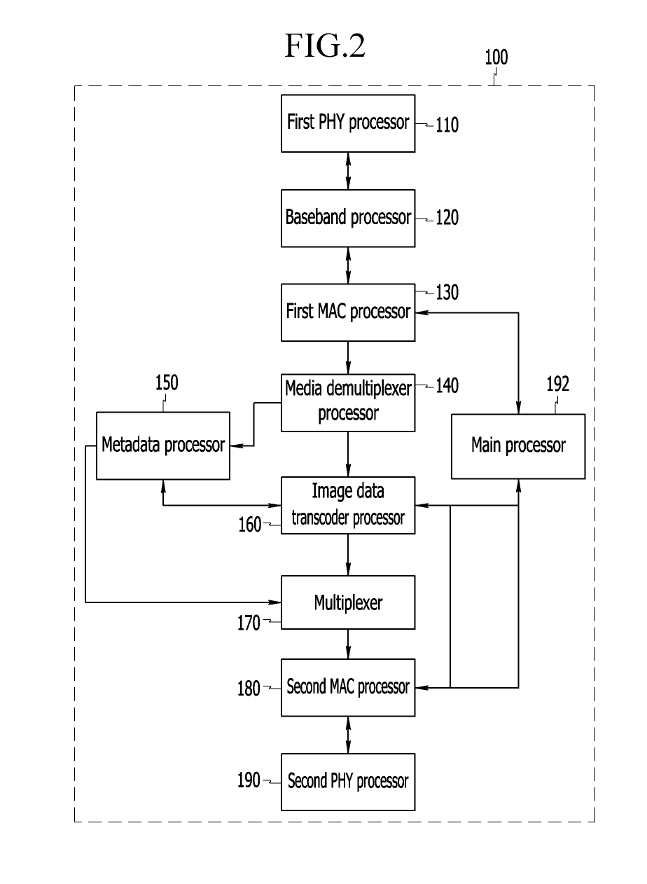

FIG. 2 is a block diagram illustrating an internal configuration of a mobile set-top box according to an exemplary embodiment of the present invention.

According to an exemplary embodiment of the present invention, a mobile set-top box 100 may include a first physical layer (PHY) processor 110, a baseband processor 120, a first media access control (MAC) processor 130, a media demultiplexer (DEMUX) processor 140, a metadata processor 150, an image data transcoder processor 160, a multiplexer (MUX) 170, a second MAC processor 180, a second PHY processor 190, and a main processor 192.

The first PHY processor 110 may perform a function of transmitting and receiving image data to and from the IPTV network 10. Specifically, the first PHY processor 110 may receive a radio frequency (RF) signal from the antennas 50 and 60, and may convert the RF signal to a baseband signal, or may convert the baseband signal to the RF signal.

The baseband processor 120 may perform a function of demodulating the baseband signal received from the first PHY processor 110.

The first MAC processor 130 may extract a packet from data received from the baseband processor 120 to thereby generate a moving picture experts group (MPEG) image data transport stream (TS). Hereinafter, the MPEG image data transport stream is referred to as “TS” for ease of description.

Here, for example, packets from the received data are cut by 184-byte unit and then are added with a 4-byte heater to construct at least one voice and image into a single stream so that packetized elementary streams (PES) for a transmission of image and voice MPEG are collected into one.

The media demultiplexer processor 140 may receive the TS from the first MAC processor 130, and may separate metadata and image data from the TS. Also, the media demultiplexer processor 140 may transmit the separated metadata to the metadata processor 150, and may transmit the separated image data to the image data transcoder processor 160. In this instance, the metadata indicates data required to image and audio information in an IPTV system, and other application data.

The metadata processor 150 may perform a function of unifying in-band metadata, existing in the TS, and out-of-band metadata, existing as a separate channel in addition to the TS, in order to transmit the in-band metadata and the out-of-band metadata to the user terminal 200. Here, the in-band metadata may be included in a TS including audio and video in an IPTV broadcasting program, and may include control information required to play an image and voice of a corresponding broadcasting program. Also, the out-of-band metadata indicates data transmitted via a TS of another channel in addition to the corresponding TS.

When an image codec of the IPTV network 10 is different from an image codec installed in the user terminal 200, the image data transcoder processor 160 may convert data to an image decodable by the user terminal 200.

The multiplexer 170 may multiplex image data and metadata and then transmit the multiplexed data to the second MAC processor 180.

The second MAC processor 180 may perform a MAC processing function suitable for a wireless access scheme of WiBro, WiMax, and TDS-CDMA for communication with the mobile set-top box 100 and the user terminal 200.

The second PHY processor 190 may perform a modulation function in order to transmit, to the user terminal 200, data received from the second MAC processor 180.

Among data received from the second PHY processor 190, image data may be transmitted to the image data transcoder processor 160 via the second MAC processor 180, and data excluding the image data may be transmitted to the first MAC processor 130 via the main processor 192.

The main processor 192 may control each module of the mobile set-top box 100 to provide the IPTV service to the user terminal 200.

For communication between the IPTV network 10 and the user terminal 200, the main processor 192 may perform a function of managing a capability of the user terminal 200 and an IP address allocated to each user terminal by the IPTV network 10 to thereby determine and control transcoding of image data for each user terminal.

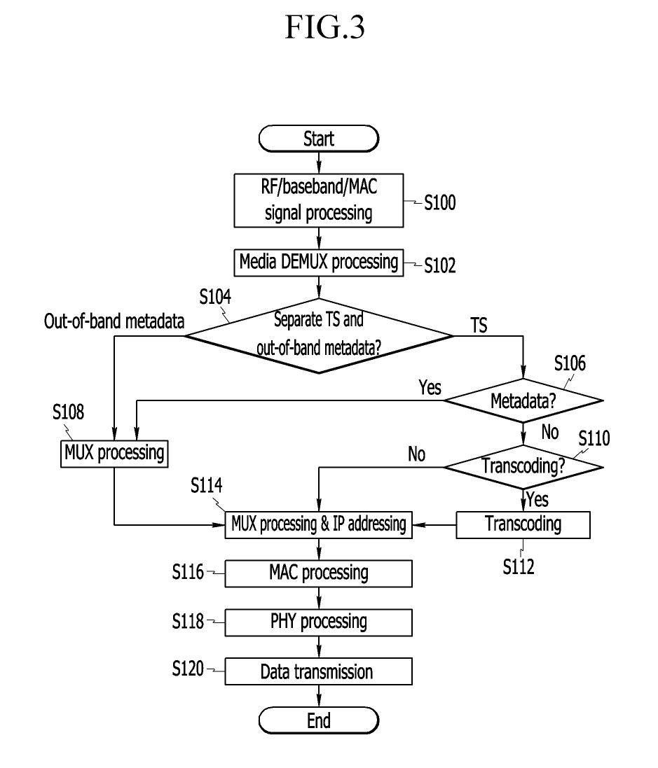

FIG. 3 is a flowchart illustrating a downlink operation for providing an IPTV service in a mobile set-top box according to an exemplary embodiment of the present invention.

A wireless signal received from the IPTV network 10 may pass through a down conversion process, a baseband signal processing process, a MAC processing process (S100).

The media demultiplexer processor 140 may perform a media demultiplexer process with respect to a plurality of TSs received through the MAC processing process, and thereby separate out-of-band metadata, provided from a plurality of channels, and a TS corresponding to a broadcasting program (S102 and S104).

The metadata processor 150 may separate in-band metadata from the separated TS, and then unify out-of-band metadata and remaining metadata excluding metadata required for image decoding in the separated in-band metadata (S106 and S108).

The image data transcoder processor 160 may extract, from the separated TS, metadata required to play image data, and may inquire a subscriber registration database for a terminal profile maintained by the user terminal 200. Specifically, the image data transcoder processor 160 may determine whether to perform transcoding depending on whether an image codec of the IPTV network 10 and an image codec of the user terminal 200 match each other (S110).

When the image codec of the IPTV network 10 is different from the image codec of the user terminal 200, the image data transcoder processor 160 may transcode metadata to image data decodable by the user terminal 200 (S112).

Next, the multiplexer 170 may multiplex the image data, the transcoded image data, and the metadata (S114).

When the set-top box 100 provides a new IP address to the user terminal 200, the main processor 192 may assign the new IP address to the user terminal 200 and then control the second MAC processor 180 to pass through a MAC processing procedure suitable for a wireless access scheme between the mobile set-top box 100 and the user terminal 200 (S114 and S116).

The main processor 192 may control the second PHY processor 190 to pass through a PHY processing procedure and then transmit data to the user terminal 200 (S118 and S120).

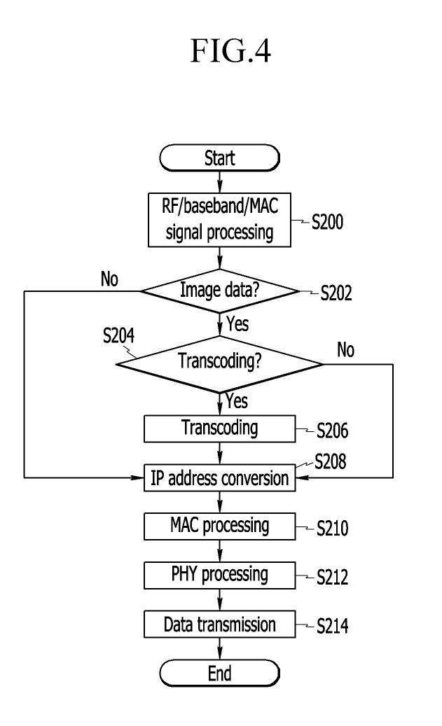

FIG. 4 is a flowchart illustrating an uplink operation for providing an IPTV service in a mobile set-top box according to an exemplary embodiment of the present invention.

A wireless signal received from the user terminal 200 may pass through a down conversion process, a baseband signal processing process, a MAC processing process (S200).

The image data transcoder processor 160 may pass through a MAC processing process. When corresponding image data corresponds to image data generated by the user terminal 200, the image data transcoder processor 160 may compare a coding scheme of image data and a coding scheme of the IPTV network 10 and thereby determine whether they are different from each other (S202 and S204).

When the coding scheme of image data is different from the coding scheme of the IPTV network 10, the image data transcoder processor 160 may transcode image data according to the coding scheme of the IPTV network 10 (S206).

When the mobile set-top box 100 provides an IP address, the main processor 192 may perform an IP address conversion process with respect to the transcoded image data (S208), may perform a MAC processing procedure via the first MAC processor 130 and a PHY processing procedure via the first PHY processor 110, and then transmit data to a base station (S210, S212, and S214).

According to the exemplary embodiment of the present invention, it is possible to provide an IPTV service to portable terminals of passengers boarding a public transportation means and thus to create a new business model.

In addition, the exemplary embodiment of the present invention may guarantee a continuity of an IPTV service and thereby may create a profitable business model through an activation of the IPTV service.

The above-mentioned exemplary embodiments of the present invention are not embodied only by an apparatus and/or method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of providing an Internet protocol television (IPTV) service in a set-top box, comprising:
separating, from a plurality of transport streams, a transport stream corresponding to a broadcasting program being transmitted to a mobile set-top box installed in a moving transportation means, as a destination, when the plurality of transport streams are transmitted from an IPTV network;
separating, from the separated transport stream, metadata required to play image data, and the image data; and
assigning an Internet protocol (IP) address to data obtained by multiplying the metadata and the image data and transmitting the same to a user terminal.

2. The method of claim 1, wherein:
the separating of the image data further comprises:
inquiring a subscriber registration database about a terminal profile maintained by the user terminal and comparing an image codec of the IPTV network and an image codec of the user terminal based on the result of inquiring; and
transcoding the metadata to image data decodable by the user terminal when the image codec of the IPTV network is different from the image codec of the user terminal.

3. The method of claim 1, wherein:
the metadata and the image data is contained in a packetized elementary stream (PES) that is a transmission form of a moving picture experts group (MPEG).

4. A mobile set-top box of providing an IPTV service, comprising:
a demultiplexer processor that separates first metadata from a transport stream corresponding to a broadcasting stream of which a destination is the mobile set-top box, and separates second metadata being transmitted via another channel, among a plurality of transport streams transmitted from an IPTV network;
a metadata processor that unifies the first metadata and the second metadata;
an image data transcoder processor that transcodes image data included in the transport stream corresponding to the broadcasting stream into image data decodable by a user terminal when an image codec of the IPTV network is different from an image codec of the user terminal;
a multiplexer that multiplexes the metadata unified by the metadata processor and the transcoded image data; and
a main processor to control data multiplexed by the multiplexer to be transmitted to the user terminal to which an IP address is assigned.

5. The mobile set-top box of claim 4, wherein:
when image data is received from the user terminal, and a coding scheme of the received image data is different from a coding scheme of the IPTV network, the image data transcoder processor transcodes the received image data according to the coding scheme of the IPTV network.

6. The mobile set-top box of claim 4, wherein:
the metadata and the image data is contained in a PES that is a transmission form of an MPEG.
